(19) United States
(12) Patent Application Publication
(10) Pub. No.: US 2024/0278925 A1
(43) Pub. Date: Aug. 22, 2024

(54) Mid-Transit Refueling Sensor System

(71) Applicant: Robert Bosch GmbH, Stuttgart (DE)

(72) Inventor: Daniel Newkirk, Owatonna, MN (US)

(21) Appl. No.: 18/112,746

(22) Filed: Feb. 22, 2023

(51) Int. Cl. B64D 39/00; B64D 47/08

(52) U.S. Cl. CPC B64D 39/00; B64D 47/08

(57) ABSTRACT

A mid-transit refueling system to be embodied upon a refueling vessel and utilized to refuel a receiving vessel during transit of the receiving vessel. The mid-transit refueling system comprises a boom arm extending a probe that engages with a receptacle of the receiving vessel. Once engaged, fuel is delivered through a conduit of the boom arm and the probe into the receiving vessel. A number of sensors are utilized to generate sensor data depicting the conditions of the mid-transit refueling. A human-machine interface (HMI) is utilized to permit a user to observe the refueling operation and provide inputs to control elements of the mid-transit refueling system during the operation.

### TECHNICAL FIELD

This disclosure relates to mid-transit refueling of traveling vessels.

### BACKGROUND

Vessels such as planes, automobiles, boats, and submarines are sometimes utilized for extended trips. Such trips can require more fuel than is possible to be carried conventionally. In some instances of such trips, a mid-transit refueling may be utilized to optimize the travel time and speed of the vessel by avoiding a stoppage of travel. In such mid-transit refueling operations, a refueling vessel must provide fuel to the traveling vessel via a probe extending from the support vessel. Alignment of the probe with a receiving port of the vessel is difficult, and often accomplished manually. It would be desirable to provide a tool-assisted option to align and connect the probe for refueling.

### SUMMARY

One aspect of this disclosure is directed to a vessel refueling system comprising a probe coupled to a fuel source, a boom arm coupled to the probe, a first sensor coupled to the boom arm, a second sensor disposed within a predefined proximity of the probe, a processor in data communication with the first sensor and the second sensor, and human-machine interface (HMI) in data communication with the processor. The fuel source houses fuel to be delivered to a receiving vessel in transit. The first sensor generates first sensor data and the second sensor generates second sensor data, wherein the first sensor data and the second sensor data are transmitted to the processor. The HMI includes a controller operable to control the motion of the boom arm. The HMI further comprises a display to present to a user the first sensor data and the second sensor data. The probe is configured to dispense fuel from the fuel source in response to a command generated by the HMI. In some embodiments, the system may further comprise a third sensor in data communication with the processor, wherein the third sensor is disposed in a proximity to the vessel receiving fuel.

The above aspects of this disclosure and other aspects will be explained in greater detail below with reference to the attached drawings.

### BRIEF DESCRIPTION OF THE DRAWINGS

FIG. 1 is an illustration of a vessel comprising a vessel refueling system.

FIG. 2 is an illustration of a refueling vessel and a receiving vessel during a vessel refueling using a first configuration of a vessel refueling system.

FIG. 3 is an illustration of a refueling vessel and a receiving vessel during a vessel refueling using a second configuration of a vessel refueling system.

FIG. 4 is an illustration of a human-machine interface (HMI) of a vessel refueling system.

### DETAILED DESCRIPTION

The illustrated embodiments are disclosed with reference to the drawings. However. it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

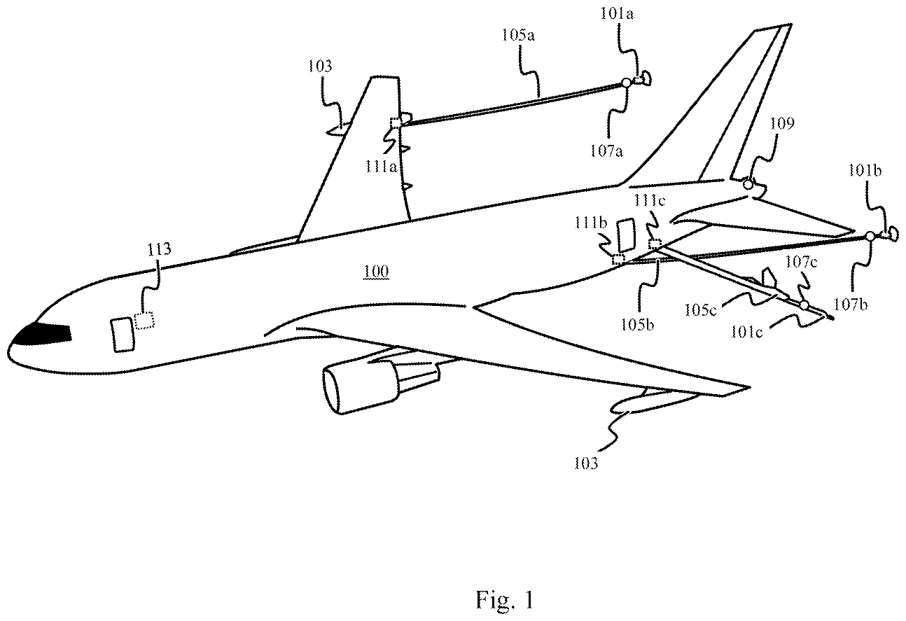

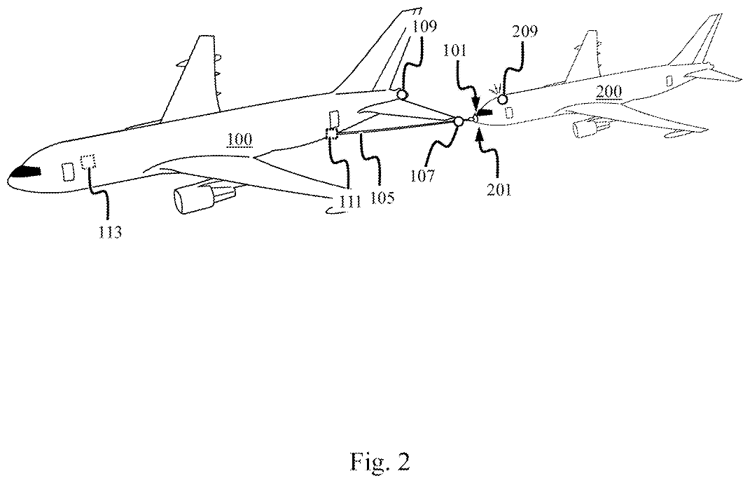

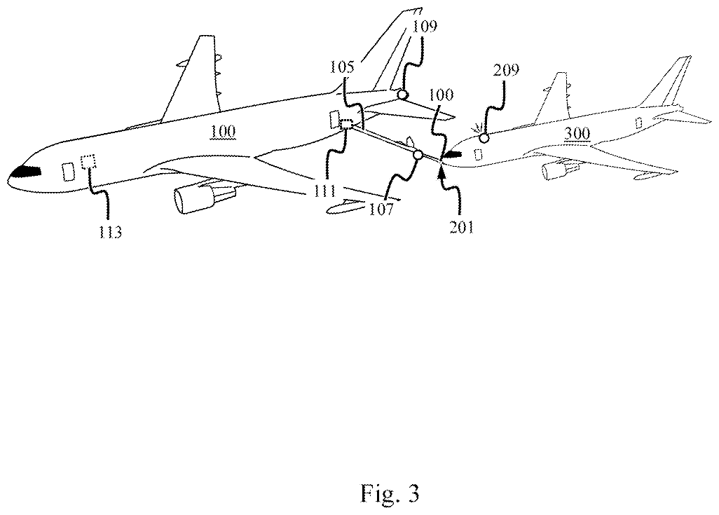

FIG. 1 is an illustration of a refueling vessel comprising a refueling system. The refueling system in FIG. 1 is embodied in conjunction with a refueling vessel 100. In the depicted embodiment, refueling vessel 100 comprises an aircraft, but other embodiments may comprise a refueling system in a water-based or land-based vessel without deviating from the teachings disclosed herein. Refueling vessel 100 provides the role of a support vessel during a mid-transit refueling and may be understood by one of ordinary skill to be type of support vessel. Refueling system delivers fuel to a receiving vessel via probe 101 that dispenses fuel housed within a fuel source 103. Probes 101 are in physical connection with refueling vessel 100 by way of a boom arm 105. In the depicted embodiment, the refueling system comprises three probes 101 and three distinct boom arms 105, but other embodiments may comprise other configurations without deviating from the teachings disclosed herein. In the depicted embodiment, each of boom arms 105 houses a fluid conduit (not shown) that provides a fluid connection between its respective probe 101 and the associated fuel source 103. Fuel travels from the fuel source 103 through the fluid conduit to a probe 101, and through probe 101 to a receiving vessel (not shown; see FIG. 2, FIG. 3) during a mid-transit refueling.

In the depicted embodiment, probes 101a and 101b are functionally identical, and primarily are distinguished by their location with respect to the chassis of refueling vessel 100. Probe 101c comprises a different configuration suitable for providing fuel to a different configuration of receiving vessel. Other embodiments may comprise a different number of probes 101 having a different arrangement or configuration without deviating from the teachings disclosed herein.

In the depicted embodiment, boom arms 105a and 105b are functionally identical, and primarily are distinguished by their location with respect to the chassis of refueling vessel 100. Boom arm 105c comprises a different configuration. In particular, boom arms 105a and 105b comprise a flexible telescoping configuration that permits a degree of mobility for their respective probes 101 in a 2-dimensional plane defined by a vertical and horizontal axis (not shown). Boom arm 105c comprises a rigid configuration that advantageously provides additional stability during refueling, but is less compact when rescinded into the chassis of refueling vessel 100.

The refueling system additional comprises a number of first sensors 107 and a second sensor 109. Each of first sensors 107 are associated with a particular one of probes 101 and boom arm 105. In the depicted embodiment, each of first sensors 107 may comprise an image sensor, such as a camera sensor or light sensor, suitable for generating image data. Other embodiments may comprise other sensor types without deviating from the teachings disclosed herein. In the depicted embodiment, second sensor 109 is disposed upon the chassis of refueling vessel 100, and the position of the second sensor 109 is known to the system such that the relative location of second sensor 109 is within a predefined proximity with respect to each of probes 101. In the depicted embodiment, second sensor 109 comprises a different sensor type than any of first sensors 107. By way of example, and not limitation, second sensor 109 may comprise a radar sensor, but other embodiments may comprise a lidar sensor, image sensor, camera, ultrasonic sensor, heat sensor, proximity sensor, or any other sensor known to one of ordinary skill that is suitable for tracking the relative position of a vessel distinct from refueling vessel 100. Other embodiments may comprise a different number or configuration of first sensor 107 and second sensor 109 without deviating from the teachings disclosed herein.

Advantageously, an embodiment comprised of differently configured first sensor 107 and second sensor 109 improves the versatility and robustness of the refueling system. By way of example, and not limitation, a first sensor 107 comprising an image sensor may be non-ideal in conditions of extreme ambient light conditions, such as darkness (e.g., during nighttime transit), or when the sun is positioned in the operational field of the first sensor 107. In such environments, a second sensor 109 having a different configuration provides a more robust operation because it is less affected by the same conditions negatively impacting first sensor 107. By way of example, and not limitation, in extreme ambient light conditions, a second sensor 109 comprised of a radar sensor provides additional data suitable to assist in the mid-transit refueling operation without being susceptible to the impacts of the ambient light conditions.

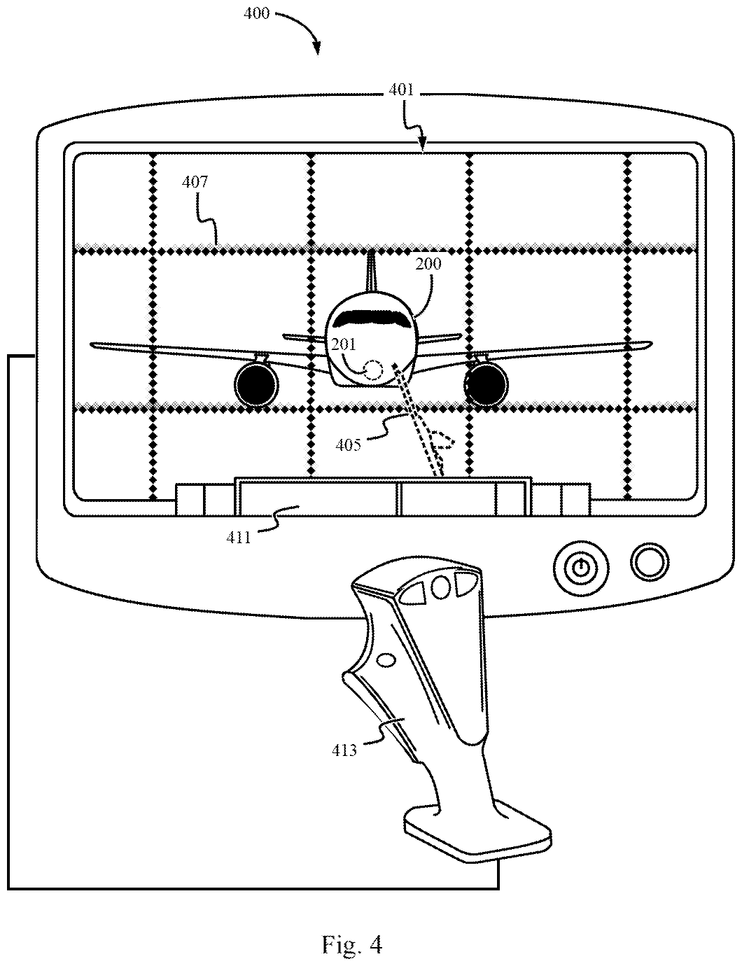

Boom arms 105 can be cumbersome and present inefficiencies for transit of refueling vessel 100. In order to accommodate for these drawbacks, each of boom arms 105 can be rescinded into the chassis of refueling vessel 100 when no mid-transit refueling operation is active or pursued. The deployment and withdrawal of each of boom arms 105 is accomplished using an associated controller 111. In the depicted embodiment, each controller 111 is configured to control the position of its respective associated boom arm 105 in 3-dimensional space. Controllers 111 may comprise automated movement functions or may be moved in response to commands received from a human-machine interface (HMI; not shown; see FIG. 4). In the depicted embodiment, each of controllers 111 are suitable to retract/deploy its respective boom arm 105 and additionally position the respective boom arm 105 for fine-adjustment of the position of the respective probe 101 during mid-transit refueling. Other embodiments may comprise other configurations with different or additional functionality without deviating from the teachings disclosed herein.

Whether the controllers 111 are operating autonomously or with directed input from a user of an HMI, the commands to operate controllers are generated by a processor 113 in data communication with the controllers 111. In the depicted embodiment, processor 113 is additionally in data communication with each of first sensors 107 and second sensor 109 and is configured to receive their respective sensor data. Once received, the data is used to compile information suitable for mid-transit refueling, such as a data log or representational data for presentation to a user of an HMI.

FIG. 2 is a diagrammatic illustration of refueling vessel 100 during a mid-transit refueling of a receiving vessel 200. In the depicted embodiment, refueling vessel 100 and vessel 200 are depicted as aircraft, but other embodiments of mid-transit refueling systems may be implemented in other forms of transit, such as trains, boats, submarines, or automobiles without deviating from the teachings disclosed herein.

During mid-transit refueling, boom arm 105 is deployed from within the chassis of refueling vessel 100 and positioned such that the associated probe 101 may interface and engage with a receptacle 201 of vessel 200. Once the probe 101 is interfaced and engaged with receptacle 201, fuel may be exchanged from one or more fuel sources (see FIG. 1) to a fuel repository (not shown) of vessel 200). The fuel repository may be a primary fuel tank of vessel 200 or may be an auxiliary or storage container within the chassis of vessel 200 without deviating from the teachings disclosed therein.

To enable the engagement of probe 101 with receptacle 201, controller 111 is used to adjust the position of probe 101 by articulating and adjusting the deployment of boom arm 105 in 3-dimensional space. This advantageously permits flexibility of the deployment of boom arm 105 to accommodate for any imprecise placement of the receiving vessel 200 in relation to refueling vessel 100 while establishing the engagement or during the mid-transit refueling operation. This adjustable deployment is additionally advantageous to respond to changing environmental conditions that necessarily affect the relative position of the receiving vessel 200 with respect to refueling vessel 100. By way of example, and not limitation, a turbulent wind condition may affect the precision of relative placement of the vessels in the depicted embodiment. In other embodiments, other conditions may be more applicable, such as in a marine environment where the refueling vessel and receiving vessel each comprise a boat, the waves of the water may affect the relative placement of the vessels with respect to each other.

The exact positioning of probe 101 via boom arm 105 using the controller 111 is assisted by utilizing the data generated by first sensor 107 and second sensor 109. In the depicted embodiment, first sensor 107 comprises an image sensor and second sensor 109 comprises a radar sensor, but other embodiments may comprise other or additional sensors without deviating from the teachings disclosed herein. The first sensor 107 and second sensor 109 generate data that indicates the local conditions and positions of the refueling vessel 100, receiving vessel 200, and the various components of the mid-transit refueling system depicted. The first sensor data and second sensor data are transmitted to processor 113, which may compile, collate, or transform the data to be used to optimize the positioning of probe 101 in real-time. In the depicted embodiment, processor 113 utilizes the received data to present a visual image for a user to observe while providing real-time command inputs to controller 111 via a human-machine interface (HMI; see FIG. 4). Other embodiments may comprise different or additional uses for the first sensor data and the second sensor data without deviating from the teachings disclosed herein.

Additional sensors may be utilized by the system to enhance the understanding of the conditions and situation during mid-transit refueling. In the depicted embodiment, a third sensor 209 is in additional data communication with processor 113, and generates third sensor data that may be utilized to enhance the understanding of the mid-transit refueling operation in real-time. In the depicted embodiment, third sensor 209 is disposed upon the chassis of receiving vessel 200, but other embodiments may comprise other or additional sensor placements without deviating from the teachings disclosed herein. In the depicted embodiment, third sensor 209 comprises a lidar sensor generating lidar data, but other embodiments may comprise other or additional sensor types without deviating from the teachings disclosed herein. By way of example, and not limitation, third sensor 209 may comprise a radar sensor, image sensor, camera, ultrasonic sensor, heat sensor, proximity sensor, or any other sensor known to one of ordinary skill that is suitable for tracking the relative position of a vessel distinct from vessel 200.

Because third sensor 209 is disposed upon the receiving vessel, the third sensor data is transmitted to processor 113 wirelessly. This wireless connection may utilize a proprietary wireless connection to enhance security and reduce transmission errors, but other embodiments may comprise other wireless data communication protocols without deviating from the teachings disclosed herein. Processor 113 may be configured to communicate wirelessly via one or more of an RF (radio frequency) specification, cellular phone channels (analog or digital), cellular data channels, a Bluetooth specification, a Wi-Fi specification, a satellite transceiver specification, infrared transmission, a Zigbee specification, Local Area Network (LAN), Wireless Local Area Network (WLAN), or any other alternative configuration, protocol, or standard known to one of ordinary skill in the art. In the depicted embodiment, processor 113 is shown to be in direct wireless communication with third sensor 209, but other embodiments may comprise one or more distinct transmitters, receivers, or transceivers affiliated with one of the refueling vessel 100 or receiving vessel 200 without deviating from the teachings disclosed herein.

FIG. 3 is a depiction of an alternative embodiment of a mid-transit refueling system. In this embodiment, boom arm 105 comprises a rigid telescoping configuration discussed above with respect to FIG. 1. In practice, the system operates in generally the same manner as discussed above with respect to FIG. 2, though the necessary arrangement of a receiving vessel 300 in relation to refueling vessel 200 is different by necessity of the configuration of boom arm 105 being different. Additionally, though boom arm 105 comprises the same degree of motion in 3-dimensional space, the rigid an configuration changes the field of motion accessible using controller 111 in relation to refueling vessel 100. In the depicted embodiment, the configuration of probe 101 may be different than as depicted in FIG. 2 without deviating from the teachings disclosed herein. In some embodiments, the differences in configurations of probe 101 or boom arm 105 may permit refueling vessel 200 to interface with a different variety of receiving vessels 300. By way of example, and not limitation, receiving vessel 300 comprises the same configuration as receiving vessel 200 (see FIG. 2) in the depicted embodiment, but other embodiments may comprise differently or additionally compatible receiving vessels without deviating from the teachings disclosed herein.

FIG. 4 is a depiction of a human-machine interface (HMI) 400 according to one embodiment of the invention disclosed herein. HMI 400 advantageously provides a user with an interface to operate controllers 111 (not shown; see FIG. 1). The HMI 400 provides a display 401 for the user to make assessments of sensor data received from sensors, such as first sensor 107 (see FIG. 1), second sensor 108 (see FIG. 1) or third sensor 209 (see FIG. 2). A processor (such as processor 113, see FIG. 1) affiliated with the system accepts the data from the sensors and prepares a representation of the data for a user. The user may then utilize this representation provided by HMI 400 to operate the mid-transit refueling system components in preparation for the mid-transit refueling operation, during the mid-transit refueling operation, and after completion of the mid-transit refueling operation. In the depicted embodiment, the representation of the sensor data is prepared and presented to the user in the form of a visual indication of receiving vessel 200. but other embodiments may present other receiving vessels without deviating from the teachings disclosed herein. In the depicted embodiment, the representation provided on display 401 comprises a visual depiction of the real-world arrangement of receiving vessel 200 (see also FIG. 2) and the other components of the mid-transit refueling system. In the depicted embodiment. HMI 400 additionally displays a representation 405 of a boom arm (such as boom arm 105b; see FIG. 1) and the location of receptacle 201 on receiving vessel 200. In the depicted embodiment, display 401 additionally comprises a rectangular grid 407 to assist a user with localization and proximity of the boom arm in 3-dimensional space. As the boom arm moves in the real space, the representation 405 correspondingly moves within the areas defined by display 401 using the received sensor data. In the depicted embodiment, display 401 provides a visual depiction of the entire range of motion of an associated fully-extended boom arm during a mid-transit refueling operation, but other embodiments may comprise other configurations without deviating from the teachings disclosed herein. In some such embodiments, the display 401 can be adjusted to show a larger or smaller space in response to inputs provided by the user of the HMI 400.

A user may provide input to HMI 400 using a number of input devices. In the depicted embodiment, display 401 may comprise a touch-screen display for direct input. Additionally, HMI 400 comprises a number of soft buttons 411 alongside the output of display 401 to provide additional specialized input, such as view control. In the depicted embodiment, direct control of an associated boom arm may be additionally operated by way of a control stick 413. Control stick 413 generates commands corresponding to motion of the boom arm and associated probe. In the depicted embodiment, control stick 413 comprises a multi-axial range of motion, wherein each axis corresponds to at least one axis of motion available to an associated boom arm via a controller (such as controller 111: see FIG. 1). In the depicted embodiment, control stick 413 comprises 2-dimensional range of motion, and the third dimension of motion is controlled using a number of buttons disposed upon control stick 413. Once the boom arm has been positioned properly, a user may additionally make use of inputs of the HMI 400 to engage the associated probe (such as probe 101; see FIG. 1) with the receptacle 201 and transfer fuel to receiving vessel 200. Other embodiments may comprise a different or additional input and output configurations of HMI 400 without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A vessel refueling system comprising:
a probe coupled to a fuel source, the fuel source housing fuel to be delivered to a vessel;
a boom arm coupled to the probe;
a first sensor coupled to the boom arm, the first sensor generating first sensor data;
a second sensor disposed within a predefined proximity of the probe, the second sensor generating second sensor data;
a processor in data communication with the first sensor and the second sensor; and
a human-machine interface (HMI) in data communication with the processor, the HMI including a controller for controlling the motion of the boom arm,
wherein the HMI further comprises a display to present to a user the first sensor data and the second sensor data, and wherein the probe is configured to dispense fuel from the fuel source in response to a command generated by the HMI.

2. The vessel refueling system of claim 1, wherein the first sensor comprises a camera sensor and the first sensor data comprises image data.

3. The vessel refueling system of claim 2, wherein the second sensor comprises a lidar sensor and the second sensor data comprises lidar data.

4. The vessel refueling system of claim 2, wherein the second sensor comprises a radar sensor, and the second sensor comprises radar data.

5. The vessel refueling system of claim 4, further comprising a third sensor generating third sensor data, the third sensor in data communication with the processor.

6. The vessel refueling system of claim 5, wherein the third sensor is disposed upon the vessel.

7. The vessel refueling system of claim 6, wherein the third sensor comprises a lidar sensor and the third sensor data comprises lidar data.

8. The vessel refueling system of claim 6, wherein the third sensor comprises a radar sensor and the third sensor data comprises radar data.

9. The vessel refueling system of claim 1, wherein the HMI comprises a control stick, the control stick generating commands that control the movement of the boom arm and probe in at least 2 dimensions.

10. The vessel refueling system of claim 1, further comprising a first aircraft from which the vessel refueling system is deployed, and wherein the vessel is a second aircraft.
